(19) United States
(12) Patent Application Publication
(10) Pub. No.: US 2009/0254269 A1
(43) Pub. Date: Oct. 8, 2009

(54) METHOD AND SYSTEM FOR AUTOMATIC ITINERARY BUILDING

(75) Inventors: David Borrillo, Rochester, MN (US); Wade Beavers, Rochester, MN (US)

Correspondence Address: PERKINS COIE LLP, P.O. BOX 1208, SEATTLE, WA, 98111-1208, US

(73) Assignee: DoApp, Inc., Minneapolis, MN (US)

(21) Appl. No.: 12/417,578

(22) Filed: Apr. 2, 2009

Related U.S. Application Data
(60) Provisional application No. 61/041,789, filed on Apr. 2, 2008.

(51) Int. Cl. G01C 21/36

(52) U.S. Cl. 701/201; 701/200

(57) ABSTRACT

A method and system calculates an itinerary for visiting a set of events, each event associated with a location and a time window. The itinerary is calculated to allow the user to arrive at each location within the associated time window. Upon user request, the method will also provide turn-by-turns directions in following the itinerary.

### CROSS REFERENCE TO RELATED APPLICATIONS

This application claims priority to provisional application No. 61/041,789 entitled “METHOD AND SYSTEM FOR SELECTING TIME- AND LOCATION-RELEVANT ADVERTISEMENTS AND ITINERARY BUILDING”, filed Apr. 2, 2008, and which is incorporated herein by reference.

### BACKGROUND

Various systems exist to determine a physical location include using a Global Positioning System (GPS) receiver system or cellular network triangulation. Other systems determine a physical location based on an IP address on a wired network, or approximating the physical location based on a coverage area of a short-range wireless network.

Other systems allow a present location to be view on a map, allowing a user to determine a present location in relation to one or more other locations. Further, a system can plot a course from one location to another, providing directions in accordance with predetermined criteria (for example, driving directions along recognized roads, avoiding toll roads, avoiding highways, etc.)

Other applications provide physical location as a linear sequence in time, for example, an itinerary for airline travel or an itinerary for a tour group. Another example includes package tracking through delivery services such as UPS or FedEx.

A need exists to automatically retrieve event information and calculate an itinerary based on both the locations of the events and time windows associated with the events.

### BRIEF DESCRIPTION OF DRAWINGS

FIG. 1 illustrates an example mobile device configured to calculate an itinerary.

FIG. 2 illustrates an example screenshot of an open house listing retrieved from a realtor website.

FIG. 3 illustrates an example procedure for automatic itinerary building based on a set of physical locations and a time window associated with each location.

FIG. 4 illustrates an example procedure for exacting event information from an open house listing.

FIG. 5A illustrates an example data structure for storing event information.

FIG. 5B illustrates an example data entry for storing event information.

### DETAILED DESCRIPTION

Responsive to a user request, a system retrieves a set of events, each event associated with a location and a time window. The system calculates an itinerary that will allow the user to visit each location within the associated time window. The itinerary can be optimized by one or more user-selected options. The system can also provide live directions to assist the user in following the itinerary over a mobile device while the user is traveling.

For example, a user can visit listed open houses on a weekend. The user automatically downloads listed open houses, where each open house is associated with a street address and a time window when the house will be shown. The user can limit the itinerary with additional filters or selection criteria, for example, only houses within a geographical area, within a specified price range, or showing during a particular time period. The system retrieves and filters the open house listings and calculates an itinerary that allows the user to visit each open house within the associated time windows. The system further provides turn-by-turn directions via a mobile device and assist the user in proceeding along the itinerary if a present physical location of the user is available.

In an alternative example, a user wishes to visit garage sales on a Saturday. Similar to the example above, the system downloads appropriate garage sale information, for example, from an online newspaper classifieds section. The system then calculates an itinerary to visit a set of selected garage sales within associated time windows.

In an alternative example, a user can be conducting deliveries or on-site appointments at specified times. Similar to the example above, the system downloads the appropriate location and time window information and calculates an itinerary. The system can provide live turn-by-turn directions via a mobile device.

In an alternative example, a user can be visiting multiple car dealerships when shopping for a new or used car. The associated time windows can be when the dealerships are open. The filtering criteria can be a dealership, a make and model of a car, a car price, or other criteria.

In an alternative example, a user can be shopping for a set of products for a specific purpose. The user can download the set of products from a third party webpage, for example, products to remodel a kitchen. The locations can be stores where the set of products are sold, where the set of products are sold across multiple stores. The time windows can be when the stores are open. An itinerary is then calculated to optimize a trip for purchasing the products.

In an alternative example, a user can be visiting multiple restaurants.

In an alternative example, a user can create and follow a tour. The locations can be tourist attractions. The time windows can be when the attractions are open. The filtering criteria can include type of attractions, price of attraction, geographical proximity, or other criteria.

In an alternative example, multiple users can meet within a time window at a specified or system-determined location, where each user is following an individual itinerary with other events. Their itineraries are calculated to optimally plan a time window during which they are all at the same location.

It will be appreciated that the system can automatically facilitate making appointments within the time windows. For example, in the open house example discussed above, a system can calculate an itinerary to visit all user-selected open houses. The system can further contact the homeowner or the realtor to book an appointment that fits within the itinerary.

It will be appreciated that the system can provide or facilitate additional services for each event. For example, in the open house example discussed above, each open house can be displayed alongside advertisements for home purchasing services, such as a mortgage broker, a title company, or an appraisal company.

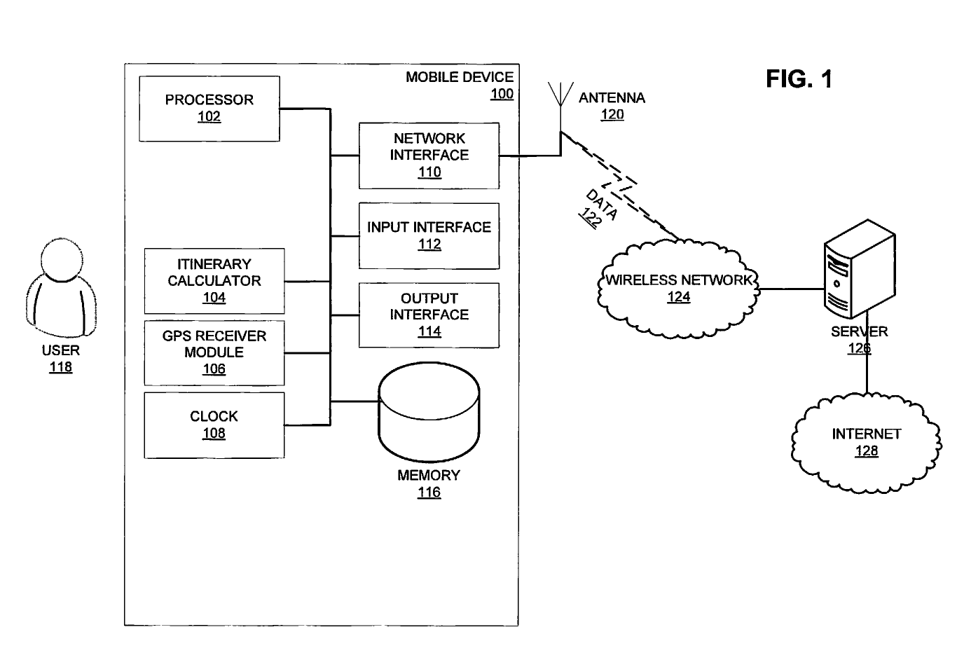

FIG. 1 illustrates an example mobile device 100 configured to calculate an itinerary. The mobile device 100 can be a cellular phone, a laptop computer, a personal digital assistant, or any other device capable of retrieving a set of events and calculating an itinerary. Responsive to a user request, the mobile device 100 can automatically retrieve event information and either calculate an itinerary or receive a calculated itinerary from the server. The mobile device 100 can then provide turn-by-turn directions to the user following the itinerary.

The mobile device 100 can include a processor 102. The processor 102 can be a general processor configured to execute computer-readable instructions.

The mobile device 100 can include an itinerary calculator 104. The itinerary calculator 104 can be a software module executing on the processor 102 configured to calculate an itinerary from a set of events. Each event can be associated with a location of the event and a time window during which the event will occur. The itinerary calculator 104 can calculate the itinerary so that the events will be visited serially, each event visited during its time window.

The itinerary calculator 104 can also receive a present location and calculate directions to help a user 118 follow the itinerary. If the itinerary calculator 104 receives an updated physical location as the mobile device 100 is moved, the itinerary calculator 104 can calculate updated directions. For example, the mobile device 100 can be moved if it is carried by the user 118 as he follows the itinerary.

In an alternative embodiment, the mobile device 100 can be in intermittent communications with a workstation, such as a personal computer. The workstation can replace the server retrieve the events and calculate the itinerary for download to the mobile device, for example, over a USB cable.

The mobile device 100 can include a GPS receiver module 106. The GPS receiver module 106 can be configured to receive GPS signals and calculate a present location of the mobile device.

Alternatively, the mobile device 100 can calculate a present location by cellular signal triangulation. Signals from one or more cellular towers, each with a known location, can be used to triangulate the mobile device 100's present location.

Alternatively, the mobile device 100 can be connected to a wired network, with an IP address from which a physical location can be calculated or approximated. For example, the mobile device 100 can plug into an Ethernet jack. The IP address can be associated with a physical location of the Ethernet jack, which approximates the present location of the mobile device 100.

Alternatively, the mobile device 100 can be in communications with a short range wireless network. For example, a short range wireless network can be a Bluetooth or a Wi-Fi network. Because the coverage area of a short range wireless network is limited, a present location of the mobile device 100 can be approximated as the physical location of the wireless network coverage area or the physical location of an access point used by the mobile device 100.

It will be appreciated that the present location can be calculated at a server which receives information from the mobile device 100. For example, the mobile device 100 can transmit one or more cellular tower identifiers along with associated signal strengths, and the server will look up the physical location of each cellular tower. From the signal strengths, the server can approximate the physical location of the mobile device 100. The approximated physical location can be transmitted to the mobile device 100.

Similarly, the mobile device 100 can transmit an IP address or a short range wireless network identifier to the server. The server can respond with a present location of the mobile device 100. This reduces the resource requirements on the mobile device 100.

The mobile device 100 can include a clock 108. The clock 108 can provide a local time, which is used in calculating the itinerary so that each event will be visited during its time window. The local time can also be used to provide alerts to the user 118 when it is appropriate to leave an event so that sufficient time is available to visit the subsequent events on the itinerary.

The mobile device 100 can include a network interface 110. For example, the network interface 110 can communicate with a cellular wireless network, a wired network such as Ethernet, or a short range wireless network. It will be appreciated that any number of network interfaces 110 can be present in the mobile device 100. Alternatively, the network interface can be configured to communicate with more than one network.

The mobile device 100 can include an input interface 112. The input interface 112 can receive user inputs from an input device and convert the user inputs into user commands. For example, input devices can include a touch screen display, a keypad, a microphone, a pointer device, a scroll wheel, or other input devices.

The mobile device 100 can include an output interface 114. The output interface 114 can transmit output to an output device in a form accessible to the user 118. For example, output devices can include a display screen, a speaker, an audio-out jack, electro-mechanical motor, or other output devices.

The mobile device 100 can include a memory 116. The memory 116 can be read-only or read-write memory accessible to the processor 102 and store data required by the mobile device 100. The memory 116 can store a set of events, a calculated itinerary and directions to follow the itinerary.

The mobile device 100 can be used by a user 118. The user can operate the mobile device 100 to calculate a desired itinerary and receive outputted directions in following the itinerary.

The mobile device 100 can include an antenna 120. The antenna 120 can be configured to communicate with a wireless network, such as a cellular network or a short range network.

It will be appreciated that an antenna is not required for a connection to a wired network. Instead, the mobile device 100 can include a wired network jack for receiving a network cable.

The mobile device 100 can transmit and receive data 122. The data can include user requests for event information, information relevant for a server to calculate an itinerary, a present location of the mobile device 100, a calculated itinerary transmitted to the server for storage, a calculated itinerary received from the server if the itinerary is calculated at the server, or other data.

The mobile device 100 can communicate with a wireless network 124. The wireless network can be, for example, a cellular network or a short-range wireless network. The wireless network 124 can include cellular towers or access points.

The mobile device 100 can communicate with a server 126. The server 126 can administer the wireless network 124. In addition, the server 126 can facilitate communication between the mobile device 100 and other networks. The server 126 can retrieve event information, calculate an itinerary, and calculate directions responsive to requests from the mobile device 100.

The mobile device 100 can communicate with the Internet 126 or other network. For example, event information can be retrieved from Internet sites such as classified ads for garage sales, realtor website listings of open houses, or other sources.

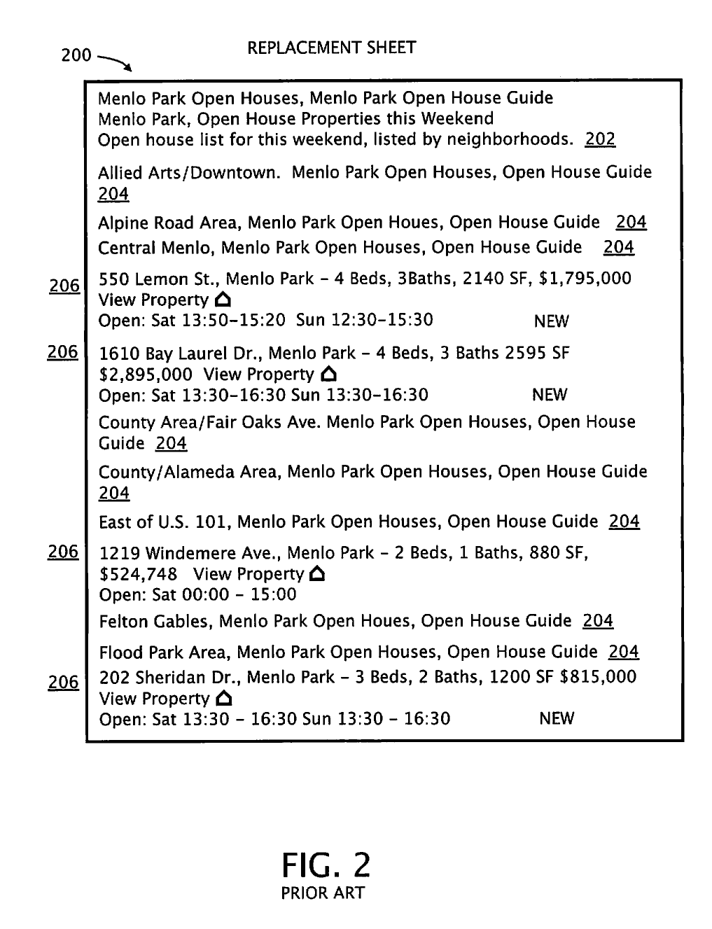

FIG. 2 illustrates an example screenshot of an open house listing retrieved from a realtor website. For example, the event information required to calculate an itinerary can be extracted from a web page accessible over the Internet. In this example, the user requests an itinerary to visit open houses within a geographical area over a weekend. The system can retrieve and parse an open house listing 200 from a realtor website for event information.

The listing 200 can include a description 202, which states the listing 200 includes open houses for the upcoming weekend, listed by neighborhood.

The listing 200 can include neighborhood headings 204. The open listings 200 can be divided into local neighborhoods of the houses being shown.

The listing 200 can include open house entries 206. Each entry 206 can represent one listed open house on the website. Information such as an address, a description of the house, an asking price, and a time window when the open house will occur can be displayed. Additional information can be available in the listing or via hyperlinks to a details webpage.

It will be appreciated that event information can be extracted from the listing 200. For example, a physical location can be the address of the entries 206. The time window can be the open house start and end times of the entries 206.

It will be appreciated that the event information can be filtered when the listings 200 are being parsed. For example, the user can only be interested in open houses occurring on a particular date, or involving houses of a certain criteria, price, or neighborhood. Entries 206 that do not fit the user criteria can be skipped by the parsing process.

It will be appreciated that event information can be retrieved from sources other than a website. For example, event information can be stored in files on a server or a local workstation in an accessible format.

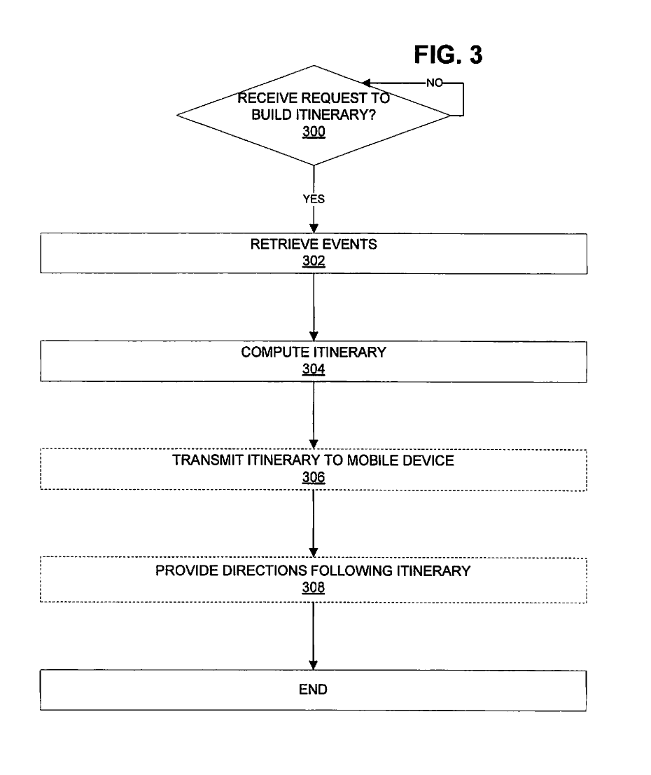

FIG. 3 illustrates an example procedure for automatic itinerary building based on a set of physical locations and a time window associated with each location. The procedure can execute on a system with a mobile device and a server as illustrated in FIG. 1.

In 300, the user can submit a request to calculate an itinerary. For example, the request can be submitted via the mobile device to the server or on a workstation such as a personal computer. The request can include user selections regarding the itinerary. For example, the user can request an itinerary to visit all open houses of homes in a geographical area with a specified price range listed on a realtor's webpage. For example, the user can request an itinerary to visit all garage sale within 10 miles of his home on the coming Saturday listed in a local newspaper and to allocate thirty minutes at each garage sale. For example, the user can request an itinerary to visit clients based on previously-made appointments retrieved from an electronic calendar. Other user selections can be used.

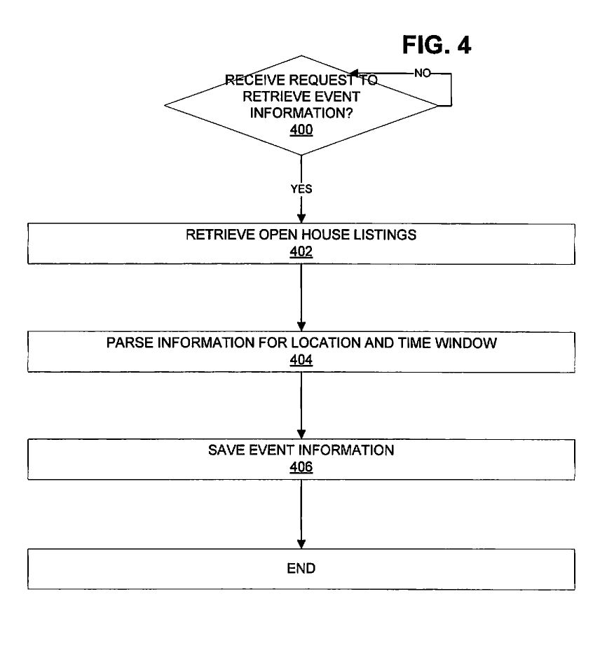

In 302, the server can retrieve a set of events matching the user request. For example, event information can be extracted from outside sources by a process illustrated in FIG. 4. Each event can be associated with a location and a time window when the event is active. For example, the events can be retrieved from a webpage over the Internet. For example, the server can access a calendar or other application to retrieve the events.

In 304, the server can compute an itinerary that will allow the user to visit each event within the associated time window. It will be appreciated that if an itinerary is impossible to calculate, for example, if too many events are included and there are time window conflicts, the server can display an error message and allow the user modify the user selections.

In 306, the server can optionally transmit the itinerary to the mobile device. For example, the itinerary can be transmitted over the wireless network to the mobile device. In an alternative embodiment, the workstation can transmit the itinerary to the mobile device, for example, via email or a USB cable.

It will be appreciated that the procedure illustrated in FIG. 3 can execute on a mobile device. Thus, the mobile device can replace the server and retrieve the event information, compute the itinerary, and provide directions. This can eliminate the need to transmit the itinerary.

In 308, the mobile device can optionally provide directions to the user when following the itinerary. The mobile device can determine a present location and provide directions to a next event in the itinerary. The mobile device can also display other travel information, such as an estimated time of arrival, remaining time of travel, and the time window of the event. The mobile device can provide options to the user to add or delete events from the itinerary, or to rearrange events.

It will be appreciated that if a present location of the mobile device is unavailable, an itinerary can still be calculated. Similarly, directions can be calculated based on a provided starting location. However, real-time turn-by-turn directions will be unavailable absent a present location of the mobile device.

In an alternative embodiment, no time window is associated with each physical location. However, the user can submit an amount of time that limits the length of the itinerary. The itinerary is then computed to cover as many of the physical locations as possible within the amount of time specified by the user. It will be appreciated that each physical location can be weighted by a priority that affects its likelihood of being included in the itinerary.

For example, a user can select a set of open houses to drive by and a block of time he has available. The procedure computes an itinerary that visits as many (or all) of the selected open houses as possible. The open houses can be selected based on user preferences, location, or other optimization factors. Because the user is not actually attending the open houses, but merely driving by, the time windows of the open houses are irrelevant.

FIG. 4 illustrates an example procedure for extracting event information from an open house listing. For example, the procedure can be executed in response to a request to retrieve event information. The user can specify a location where event information is stored, for example, a webpage as illustrated in FIG. 2, and the procedure extracts relevant event information from the webpage.

It will be appreciated that the procedure can execute on any computing device in communication with the user and the requested event information, for example, the mobile device, a workstation, or a server.

In 400, the server can test whether a user request to retrieve event information has been received. For example, the user can specify a set of events for which information must be received. The user can also specify where the event information is stored, a data source from which the event information can be extracted, and any user criteria that will be used to filter the events.

In this example, the event information is a set of open houses occurring in an upcoming weekend within a geographical area defined by neighborhoods.

In 402, the server can retrieve the open house listings from a realtor's website or other source. For example, the event information source can be user-specified, or a third party can specify different sources for different types of event information of interest to the user.

Third parties can organize their events into compatible formats to encourage event information retrieval and itineraries involving their events. Aggregators can collect event information for download by users.

In 404, the server can parse the retrieved information for a location and a time window associated with each event. For example, an address and a time of each relevant open house can be extracted from the realtor's website.

For example, a retrieved webpage can be in HTML format. The server can parse the text portion of the webpage to determine event information associated with each event.

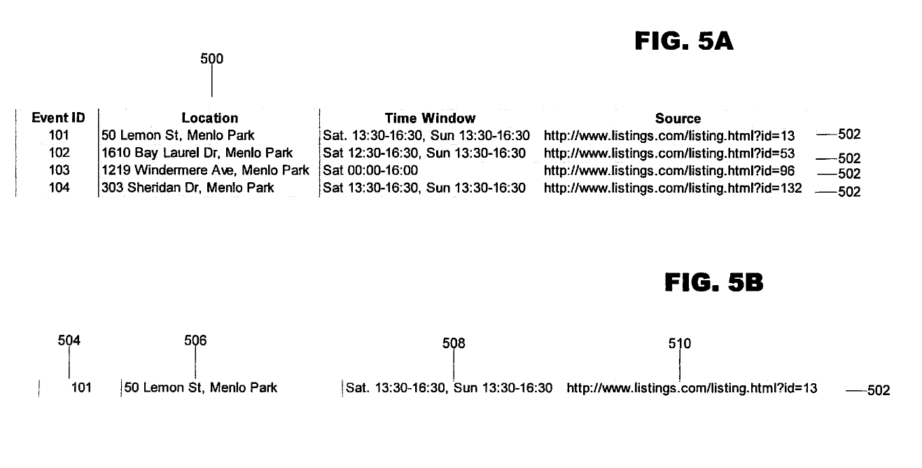

In 406, the server can store the set of event information in a data structure as illustrated in FIGS. 5A and 5B. The data structure can exist in a server-accessible memory. Once the event information is stored, they can be filtered with the user criteria and used to calculate an itinerary. It will be appreciated that the filtering can occur as the event information is being parsed. Thus, irrelevant events are not stored.

The extracted event information can be filtered based on user criteria. An itinerary can be calculated from the remaining events, as illustrated above.

FIG. 5A illustrates an example data structure for storing event information. A data structure 500 can be stored in an accessible memory and store event information for later processing. For example, an itinerary can be calculated from the events stored in the data structure. The event information can be parsed from an outside source, such as a webpage. Parsing can occur by a procedure illustrated in FIG. 4 on a realtor's open house listing webpage illustrated in FIG. 3.

The data structure 500 can be saved as a two-dimensional array, a linked list, a table, or any other data structure configured to store a set of event information. The data structure 500 can be stored in random access memory or saved to other rewritable or non-volatile memory.

The data structure can include one or more data entries 502. Each entry 502 can represent an event and its associated information. For example, an event can be an open house listing, a garage sale listing, an on-site appointment, or any event that can be associated with a location and a time window.

The information of data structure 500 can be used to calculate an itinerary. The itinerary can allow the user to visit each event at the associated location within the specified time window. Various algorithms can be used to calculate the itinerary. In addition, the algorithm can be optimized by user selections. For example, the user can specify the itinerary must avoid toll road. The user can specify the itinerary must avoid highways and freeways. The user can specify the itinerary must provide a minimum amount of time at one or more events. The user can specify the itinerary must provide a minimum total amount of time spent at all events. The user can specify the itinerary must not exceed a maximum trip time. The user can specify the itinerary must not exceed a maximum travel time.

FIG. 5B illustrates an example data entry 502 for storing event information. Each entry 502 can represent an event and its associated information. Information for the entry 502 can be parsed, as discussed above. For example, each entry 502 can be stored in an array, a linked list, or any other data structure in memory.

Each entry 502 can include an event identifier 504. The event identifier 504 can associate each entry 502 and be a globally unique identifier. The event identifier 504 can be used to identify each event within memory. For example, the event identifier 504 can be a sequence of alpha-numeric characters.

Each entry 502 can include a physical location 506. For example, the physical location 506 can be a street address, a set of longitude and latitude coordinates, or any other representation of a location. The physical location 506 can be used to calculate an itinerary that will visit the event. The itinerary can visit one physical location after another, as discussed above.

Each entry 502 can include a time window 508. For example, the time window 508 can be a period of time when the event will occur, such as when an open house will be occurring. The time window 508 can be used to calculate an itinerary that will visit the event at the proper time. The itinerary can be calculated to arrive at the event at a specified point within the time window 508. For example, an itinerary can visit an open house any time after the open house begins but before thirty minutes from the end of the open house. This will allow the user time to participate in the open house before the event ends.

Each entry 502 can include an entry source 510. An entry source 510 can refer to a location where the event information was retrieved. For example, the event information can be parsed from a webpage, as discussed above, and the entry source 510 can be a URL address for the webpage. Alternatively, the event information can be retrieved from an external file and the entry source 510 can specify the file name and location.

It will be appreciated that each entry 502 can include other fields, defined by programmer or user. Other fields can be added, such as graphics, user-added comments, travel directions, traffic conditions, etc. Additional fields can provide additional functionality or options when calculating an itinerary.

An example embodiment of the present invention can be a method. The method can include automatically retrieving a set of events, each event associated with a location and a time window. The method can include computing an itinerary to visit each location within the associated time window. The method can include transmitting the itinerary to a mobile device. The method can include, responsive to receiving a GPS-determined present location, outputting directions to assist a user in following the itinerary. The itinerary can be computed to meet at least one of the following conditions: toll avoidance, freeway avoidance, provide a minimum amount of time spent at each event, provide a minimum total amount of time spent at all events, not exceed a maximum trip time, and not exceed a maximum traveling time. The method can include notifying the user if an itinerary based on the events is impossible to calculate due to location or time window restrictions. The method can include, responsive to user selecting an event to remove from the set of events, re-computing the itinerary based on a new set of events. The set of events can be automatically retrieved from a user-specified location and filtered based on user criteria. The set of events can be a set of open houses retrieved from a realtor's website, each location is a home address, and each time window is a period when the open house will be occurring.

Another example embodiment of the present invention can be a mobile device. The mobile device can include a data transceiver configured to retrieve a set of events, each event associated with a location and a time window. The mobile device can include a position-determining module configured to determine a present location of the mobile device. The mobile device can include a processor configured to compute an itinerary from the present location to the set of events, the itinerary visiting each event at the associated location within the associated time window. The mobile device can include an output device configured to provide directions to assist a user in following the itinerary. The itinerary can be computed to meet at least one of the following conditions: toll avoidance, freeway avoidance, provide a minimum amount of time spent at each event, provide a minimum total amount of time spent at all events, not exceed a maximum trip time, and not exceed a maximum traveling time. The output device can be further configured to notify the user if an itinerary based on the events is impossible to calculate due to location or time window restrictions. The set of events can be automatically retrieved from a user-specified location and filtered based on user criteria. The set of events can be a set of open houses retrieved from a realtor's website, each location is a home address, and each time window is a period when the open house will be occurring.

Another example embodiment of the present invention can be a method. The method can include automatically retrieving a set of events, each event associated with a location and a time window. The method can include computing an itinerary to visit each location within the associated time window. The method can include responsive to receiving a GPS-determined present location, outputting directions to assist a user in following the itinerary.

Another example embodiment of the present invention can be a computer-readable medium including instructions adapted to execute a method for calculating an itinerary. The method can include automatically retrieving a set of events, each event associated with a location and a time window. The method can include computing an itinerary to visit each location within the associated time window. The method can include transmitting the itinerary to a mobile device. The method can include, responsive to receiving a GPS-determined present location, outputting directions to assist a user in following the itinerary. The itinerary can be computed to meet at least one of the following conditions: toll avoidance, freeway avoidance, provide a minimum amount of time spent at each event, provide a minimum total amount of time spent at all events, not exceed a maximum trip time, and not exceed a maximum traveling time. The method can include notifying the user if an itinerary based on the events is impossible to calculate due to location or time window restrictions. The method can include, responsive to user selecting an event to remove from the set of events, re-computing the itinerary based on a new set of events. The set of events can be automatically retrieved from a user-specified location and filtered based on user criteria. The set of events can be a set of open houses retrieved from a realtor's website, each location is a home address, and each time window is a period when the open house will be occurring.

It will be appreciated to those skilled in the art that the preceding examples and embodiments are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A method, comprising:
automatically retrieving a set of events, each event associated with a location and a time window;
computing an itinerary to visit each location within the associated time window; and
transmitting the itinerary to a mobile device.

2. The method of claim 1, further comprising:
responsive to receiving a GPS-determined present location, outputting directions to assist a user in following the itinerary.

3. The method of claim 1, wherein the itinerary is computed to meet at least one of the following conditions: toll avoidance, freeway avoidance, provide a minimum amount of time spent at each event, provide a minimum total amount of time spent at all events, not exceed a maximum trip time, and not exceed a maximum traveling time.

4. The method of claim 1, further comprising:
notifying the user if an itinerary based on the events is impossible to calculate due to location or time window restrictions.

5. The method of claim 4, further comprising:
responsive to user selecting an event to remove from the set of events, re-computing the itinerary based on a new set of events.

6. The method of claim 1, wherein the set of events is automatically retrieved from a user-specified location and filtered based on user criteria.

7. The method of claim 1, wherein the set of events is a set of open houses retrieved from a realtor's website, each location is a home address, and each time window is a period when the open house will be occurring.

8. A mobile device, comprising:
a data transceiver configured to retrieve a set of events, each event associated with a location and a time window;
a position-determining module configured to determine a present location of the mobile device;
a processor configured to compute an itinerary from the present location to the set of events, the itinerary visiting each event at the associated location within the associated time window; and
an output device configured to provide directions to assist a user in following the itinerary.

9. The mobile device of claim 8, wherein the itinerary is computed to meet at least one of the following conditions: toll avoidance, freeway avoidance, provide a minimum amount of time spent at each event, provide a minimum total amount of time spent at all events, not exceed a maximum trip time, and not exceed a maximum traveling time.

10. The mobile device of claim 8, wherein the output device is further configured to notify the user if an itinerary based on the events is impossible to calculate due to location or time window restrictions.

11. The mobile device of claim 8, wherein the set of events is automatically retrieved from a user-specified location and filtered based on user criteria.

12. The mobile device of claim 11, wherein the set of events is a set of open houses retrieved from a realtor's website, each location is a home address, and each time window is a period when the open house will be occurring.

13. A method, comprising:
automatically retrieving a set of events, each event associated with a location and a time window;
computing an itinerary to visit each location within the associated time window; and
responsive to receiving a GPS-determined present location, outputting directions to assist a user in following the itinerary.

14. A computer-readable medium including instructions adapted to execute a method for calculating an itinerary, the method comprising:
automatically retrieving a set of events, each event associated with a location and a time window;
computing an itinerary to visit each location within the associated time window; and
transmitting the itinerary to a mobile device.

15. The medium of claim 14, the method further comprising:
responsive to receiving a GPS-determined present location, outputting directions to assist a user in following the itinerary.

16. The medium of claim 14, wherein the itinerary is computed to meet at least one of the following conditions: toll avoidance, freeway avoidance, provide a minimum amount of time spent at each event, provide a minimum total amount of time spent at all events, not exceed a maximum trip time, and not exceed a maximum traveling time.

17. The medium of claim 14, the method further comprising:
notifying the user if an itinerary based on the events is impossible to calculate due to location or time window restrictions.

18. The medium of 17, the method further comprising:
responsive to user selecting an event to remove from the set of events, re-computing the itinerary based on a new set of events.

19. The medium of claim 14, wherein the set of events is automatically retrieved from a user-specified location and filtered based on user criteria.

20. The medium of claim 19, wherein the set of events is a set of open houses retrieved from a realtor's website, each location is a home address, and each time window is a period when the open house will be occurring.

21. A method, comprising:
automatically retrieving a set of events, each event associated with a location;
receiving a user-selected time window during which the events will be visited;
computing an itinerary to visit as many events as possible during the time window; and
transmitting the itinerary to a mobile device.

22. The method of claim 21, further comprising:
responsive to receiving a GPS-determined present location, outputting directions to assist a user in following the itinerary.

23. The method of claim 21, wherein the set of events is automatically retrieved from a user-specified location and filtered based on user criteria.

24. The method of claim 21, wherein the set of events is a set of open houses retrieved from a realtor's website and each location is a home address.

25. The method of claim 21, wherein the events that are visited are selected based on an event priority.
